(19) United States
(12) Patent Application Publication
(10) Pub. No.: US 2025/0122739 A1
(43) Pub. Date: Apr. 17, 2025

(54) SKIMMER BOX

(71) Applicant: PLUNGIE IP PTY LTD, Crestmead, Queensland (AU)

(72) Inventors: Mayer JUNG, Crestmead, Queensland (AU); Ben PETERSEN, Crestmead, Queensland (AU); Aiden THOMLINSON, Crestmead, Queensland (AU)

(21) Appl. No.: 18/686,530

(22) PCT Filed: Aug. 25, 2022
(86) PCT No.: PCT/AU2022/051016

§ 371 Date: Feb. 26, 2024

(30) Foreign Application Priority Data
Aug. 25, 2021 (AU) 2021221684

(51) Int. Cl. E04H 4/12

(52) U.S. Cl. CPC E04H 4/1272

(57) ABSTRACT

A skimmer box for a pool having a body portion and a conduit portion extending from the body portion. The conduit portion is receivable by an aperture of the pool to fluidly connect an inside of the pool with a cavity inside the body portion. The conduit portion has connectors to operatively connect with a corresponding connector in the pool, preferably via a mounting component embedded in the pool wall, to mount the skimmer box thereto.

### FIELD OF THE INVENTION

The invention relates to a skimmer box and skimmer box assembly. In particular, the invention relates, but is not limited, to a skimmer box and skimmer box assembly that is operatively connectable with a pool shell.

### BACKGROUND TO THE INVENTION

Reference to background art herein is not to be construed as an admission that such art constitutes common general knowledge.

Skimmer boxes are commonly used in pools to skim the surface of the pool water and provide an inlet for the pool water to be filtered by a filtration system. An opening is provided in the pool shell at the intended waterline to enable pool water to enter a skimmer box located behind the opening. The skimmer box typically then has a basket to catch debris and an outlet connected to a pool suction line for filtration of the water.

To install a skimmer box an opening is required in a wall of the pool. The skimmer box can then be located in the opening, supported underneath (e.g. by the ground or other means), and the opening around the skimmer box then filled in (with concrete in the case of a concrete pool, for example) to make the skimmer box water tight and integral with the pool. A fascia or escutcheon is often provided around the skimmer box opening for protective and/or aesthetic reasons.

Skimmer box installation is therefore quite an involved process. Furthermore, it affects the order of construction and can affect pool build timeline. For example, the pool must be largely constructed to allow installation of the skimmer box. Once at the appropriate stage in construction, the skimmer box is required before construction of the pool can be completed. Should a skimmer box be unable to be supplied, damaged, or missing during installation, for example, delays in overall pool construction can occur.

Because the skimmer box is effectively integrated into the pool, should it become installed incorrectly, damaged, or leaky, it is often necessary to deconstruct part of the pool, remove and replace the skimmer box, and then reconstruct the pool. This is not only time consuming and expensive, but can result in inconsistencies in the pool finish.

Another issue with skimmer boxes is the propensity for components contained inside to float upward. This often occurs because the components are made of plastics that are less dense than the pool water. This can be exacerbated when air is caught underneath a skimmer box plate above the debris basket. Some skimmer box plates have an air valve, but it does not always overcome the problem entirely, particularly if the skimmer box plate itself is buoyant. Should the skimmer box plate become dislodged, any suction cleaners typically fail to operate under the reduced pressure.

Yet a further issue with skimmer boxes is the aesthetic appearance of the lid. It disrupts the pool surrounds and is typically made of plastic which can break and ship, particularly after UV exposure from the sun. Attempts have been made to construct seamless lids from the tiles or other pool surround material. This is often done by affixing the pool surround material to the skimmer box lid itself. However, the pool surrounds are of variable height depending upon materials chosen. Notably, concrete and tile thickness can vary significantly from pool to pool. It is therefore often needed to manually build up and try to match the skimmer box lid material height to that of the surrounds which his time consuming and difficult.

### OBJECT OF THE INVENTION

It is an aim of this invention to provide a skimmer box which overcomes or ameliorates one or more of the disadvantages or problems described above, or which at least provides a useful alternative.

Other preferred objects of the present invention will become apparent from the following description.

### SUMMARY OF INVENTION

In one form, although it need not be the only or indeed the broadest form, there is provided a skimmer box for a pool, the skimmer box comprising:
a body having a cavity therein;
a conduit extending from the body, the conduit being configured to be received in an aperture of the pool and fluidly connect an inside of the pool with the cavity; and
one or more connectors configured to operatively connect with a corresponding connector in the pool to mount the skimmer box thereto.

The body may be tapered. The body may be substantially rectangular. The body may have a substantially square cross-section across at least a third of its length, preferably across at least a half of its length. The body may have an opening at an upper end thereof. The body may have an outlet at an end thereof. The body may have an opening at an opposite end to an end configured to receive a lid.

The conduit may have a door. The door may be hinged at a lower end. The door may be buoyant. The one or more connectors are preferably located on the conduit. The one or more connectors may be located on an inner surface of the conduit. The one or more connectors may comprise projections. The projections may be in the form of tabs. A plurality of connectors may be provided and the projections may extend inwardly toward each other. The projections may be resiliently deformable.

In another form, there is provided a skimmer box assembly for a pool, the skimmer box assembly comprising:
a skimmer box having a conduit with one or more skimmer box connectors; and
a mounting component having a frame portion with one or more pool side connectors, the mounting component being configured to be affixed to or into a pool wall;
wherein the skimmer box connectors operatively connect with the pool side connectors to mount the skimmer box into a wall of the pool.

The skimmer box is preferably a skimmer box as hereinbefore described.

The frame of the mounting component may have an opening therethrough. The mounting component may have a skirt portion. The skirt portion may be configured to be received by an aperture of the pool, preferably an aperture in a wall of the pool. The mounting component may comprise one or more securement members. The securement members may be in the form of ribs. The ribs may be spaced apart around a periphery of the mounting component. An inner surface of the frame may be smooth. The inner surface of the frame may be configured to line the aperture of the pool.

The mounting component may comprise a channel. The channel may be U-shaped. The channel may be configured to receive an end of the conduit of the skimmer box. The pool side connectors may be located in the channel. The pool side connectors may comprise cut-outs in the channel. The cut-outs may be configured to receive protrusions of the skimmer box.

The mounting component may have a support member. The support member may be elongate. The mounting component may comprise a socket. The socket may be located on the support member. The socket may correspond to a protrusion of the skimmer box. The socket may be configured to support the skimmer box when connected to the mounting component.

The skimmer box assembly may further comprise a fascia. The fascia may be configured to cover the channel of the mounting component and/or distal end of the conduit of the skimmer box.

The skimmer box assembly may further comprise a basket assembly. The basket assembly may comprise one or more of a basket, a skimmer box plate, and a dress ring. The basket may comprise a collar. The basket may comprise one or more magnets (or at least a magnetically attractive material). The magnets may be located on or in the collar. The collar may comprise cut-outs. The magnets may be located on opposite sides of the collar. The cut-outs may be located on opposite sides of the collar spaced apart from the magnets.

The skimmer box plate may comprise a hole. The hole may be configured to connect vacuum apparatus. The skimmer box plate may comprise a valve. The skimmer box plate may comprise a handle. The skimmer box plate may comprise one or more magnets (or at least a magnetically attractive material). The magnets may be located on opposite sides of the skimmer box plate.

The dress ring may be configured to receive and support the basket. The dress ring may have magnetically attractive components. The magnetically attractive components may comprise magnets or a magnetic metal such as a ferrous or steel component. The basket assembly may be held together by the magnetic attraction of the skimmer box plate, basket, and dress ring.

The skimmer box assembly may comprise a lid assembly. The lid assembly may comprise a lid. The lid assembly may comprise a sleeve. The lid assembly may comprise one or more spacers to adjust the height of the lid. The lid may comprise a tool receptor. The lid may be reversible with a hollow in one side to accommodate pool surround materials such as tiles. The lid may comprise magnetic materials to magnetically attract the lid to the sleeve. The sleeve may comprise a shelf. The sleeve may comprise magnetic materials to hold the lid. The lid assembly may comprise one or more packers.

The skimmer box assembly may comprise one or more pipe supports. The pipe supports may comprise at least one annulus configured to receive a pipe. The pipe supports may comprise cable or wire clips to retain cable or wire thereto. The pipe supports may be removable connected to the skimmer box.

In another form, there is provided a pool having a mounting component affixed to or into a pool wall in a wall for reception of a skimmer box as hereinbefore described. The mounting component is preferably embedded into the pool wall. The pool may be a cast concrete pool and the mounting component may be embedded into the pool wall as the pool is cast.

In another form, there is a provided method of affixing a skimmer box to a pool, the method comprising the steps of:
inserting a conduit of the skimmer box into an aperture located in the pool;
connecting one or more skimmer box connectors of the skimmer box with a corresponding connector in the pool to mount the skimmer box thereto.

The method may further comprise the step of affixing a mounting component to the pool, preferably to a wall of the pool. The step of affixing the mounting component to the pool may comprise embedding the mounting component into the wall of the pool. The pool may be a cast concrete pool and the mounting component may be moulded into the pool during casting.

A method of constructing a pool, the method comprising:
preparing a pool mould including locating a skimmer box mounting component in the mould;
pouring a cementitious material into the mould, and allowing it to set, to form a concrete pool shell;
removing the pool shell from the mould with the skimmer box mounting component embedded therein.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 illustrates an exploded perspective view of a skimmer box assembly;

FIG. 2 illustrates a perspective view of a mounting component of the skimmer box assembly adjacent a desired skimmer box location of a pool shell;

FIG. 3 illustrates the pool shell of FIG. 2 with the mounting component inserted therein and a skimmer box located adjacent;

FIG. 4 illustrates a side cross-sectional view of FIG. 3;

FIG. 5 illustrates the side cross-sectional view of FIG. 4 with the skimmer box inserted into the pool shell;

FIG. 6 illustrates a perspective view of the skimmer box inserted into the pool shell of FIG. 5 with a fascia located adjacent;

FIG. 7 illustrates the perspective view of FIG. 6 with the fascia affixed to the skimmer box;

FIG. 8 illustrates a rear view of the skimmer box assembly;

FIG. 9 illustrates a cross-sectional view taken along line A-A of FIG. 8;

FIG. 10 illustrates an exploded perspective view of a basket assembly;

FIG. 11 illustrates an exploded perspective view of a height adjustment portion of a skimmer box lid assembly;

FIG. 12 illustrates an exploded perspective view of a locking portion of a skimmer box lid assembly;

FIG. 13 illustrates an exploded perspective view of a tile thickness packer adjustment portion of a skimmer box lid assembly; and

FIG. 14 illustrates a perspective view of the skimmer box supporting various pipework.

### DETAILED DESCRIPTION OF THE DRAWINGS

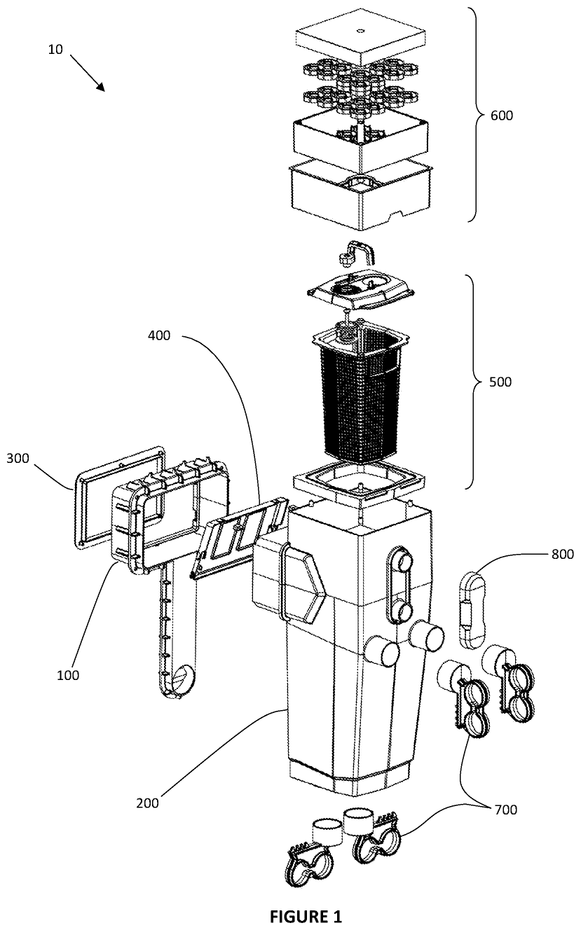

FIG. 1 illustrates an exploded view of a skimmer box assembly 10 having a mounting component 100, a skimmer box 200, a fascia 300, a door 400, a basket assembly 500, a lid assembly 600, pipe supports 700, and a cover plate 800. In use the components are integrated and connected together, with the mounting component 100 being affixed to, preferably by being embedded into, a pool shell.

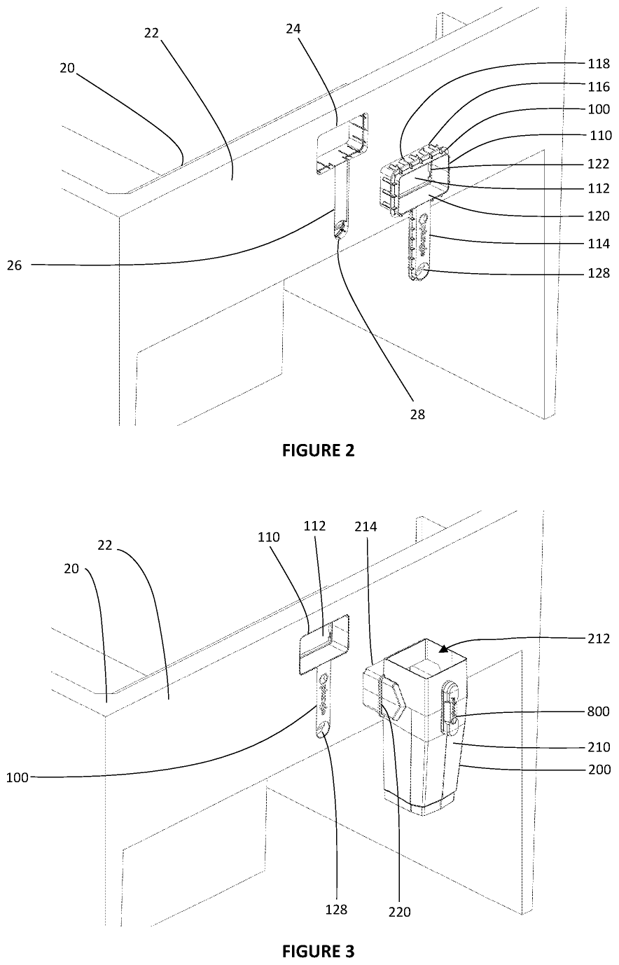

FIG. 2 illustrates a portion of a pool shell 20 having a pool wall 22 with an aperture 24 therein. The outer surface of the pool wall 22 also has an indentation 26 adjacent the aperture 24. The indentation 26 has a recess 28 spaced apart from the aperture 24. The aperture 24 and indentation 26 collective correspond to a shape of the mounting component 100 which is illustrated spaced apart from the pool wall 22.

The mounting component 100 has an open frame 110, with an opening 112 therethrough, and a support member 114. The open frame 110 has a skirt portion 116 that corresponds to the aperture 24 of the pool shell 20. Whilst the aperture 24 of the pool 20 and frame 110 of the mounting component 100 are rectangular in the figures, and whilst this is a generally preferred shape, it should be appreciated that other shaped apertures 24 and frames 110 may be utilized.

A plurality of securement members in the form of ribs 118 are provided around a periphery of the mounting component 100. The ribs 118 are spaced apart substantially equidistantly, but it should be appreciated the spacing could be varied. A socket 128 is provided in the support member 114 to receive a support portion of skimmer box 100.

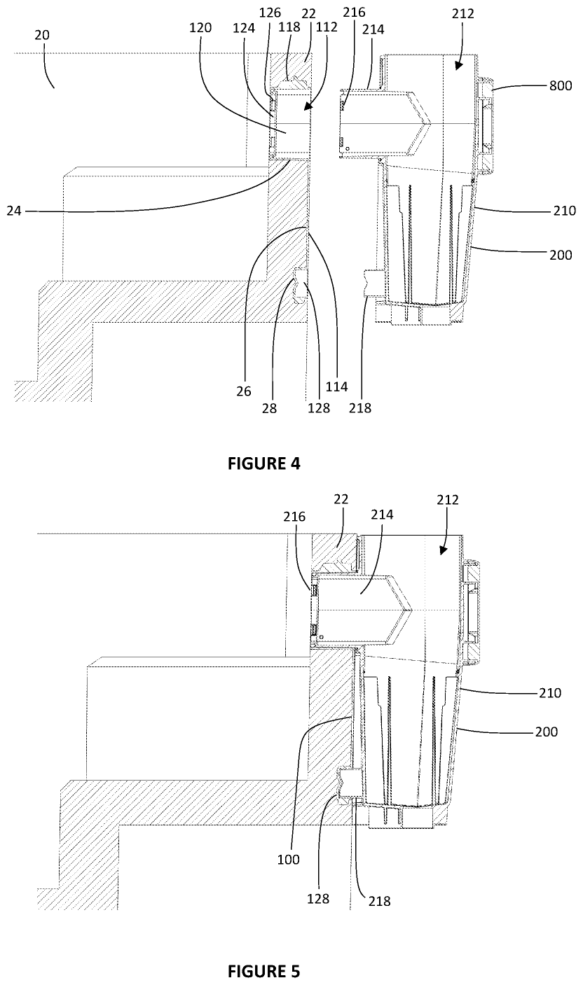

The inner surface 120 of the frame 110 is smooth and generally forms a liner for the aperture 24. At an end of the inner surface 120 is a connector 122 configured to connect with a corresponding connector of the skimmer box 100 as described in further detail in relation to FIG. 4.

The mounting component 100 may be mounted into an already formed pool shell 20. However, it is preferred that it is formed as part of the pool 20 during construction. For a concrete moulded pool 20, the mounting component 100 may be inserted into a pool mould (not shown) and cast into the pool 20 during manufacturing. The ribs 118 assist with anchoring of the mounting component 100 within the pool wall 22 of the pool shell 20.

FIG. 3 illustrates the mounting component 100 located in the pool shell wall 22 of the pool 20. The aperture 24 and indentation 26 of the pool wall 22 receive the mounting component 100 such that it is embedded therein and sits flush with the outer surface of the wall 22. When installed, the mounting component 100 effectively creates a tunnel through the pool wall 20. The skimmer box 200 is shown a short distance from the mounting component 100, ready to be connected, and supported by, the mounting component 200.

FIG. 4 illustrates a cross-sectional view of FIG. 3 where various components can be seen more clearly. The skimmer box 200 comprises a body 210 having a cavity 212 therein. A conduit 214 extends transversely from the body 210. The conduit 214 is sized and shaped to be slidably inserted into the opening 112 of the mounting component 100, located in aperture 24 of the wall 22 of the pool 20, to fluidly connect the inside of the pool 20 with the cavity 212 of the skimmer box 200. At a distal end of the conduit 214 are skimmer box connectors 216 configured to connect to corresponding pool side connectors 126 of the mounting member 100. In the illustrated form the pool side connectors 126 are in the form of cut-outs in a U-shaped channel 124 of the frame 110 of the mounting component 100. The cut-outs are shaped and sized to receive and retain projections of the skimmer box connector 216 therein (as shown in FIG. 5). The projections may be resiliently deformable.

The conduit has a flange 220 located adjacent the body 210 to assist with correct location, insertion depth, alignment, and sealing of the conduit with the mounting component 100. At an opposite end of the body 210 to the conduit 214 of the skimmer box 200 is a support portion in the form of a protrusion 218 sized and shaped to be received by the socket 128 of the mounting component 100. The protrusion 218 is effectively a male member received by a correspondingly sized and shaped female member to align and support the skimmer box 200 when connected with the mounting component 100 in the pool wall 22.

FIG. 5 illustrates the skimmer box 200 connected to the pool 20 via mounting component 100. The conduit 214 extends from the skimmer box 200 located outside the pool wall 22, through the aperture 24, to the pool side connector 122 adjacent the inside of the pool. The skimmer box connector 216 is connected to the pool side connector 122 of the mounting member 100 and the protrusion 218 of the skimmer box 200 is located inside the socket 128 of the mounting component 100 such that the body 210 of the skimmer box 200 is spaced from the pool wall 22 at its lower end. As both the pool wall 22 and body 210 of the skimmer box 200 are tapered, this spacing is pre-determined to ensure the skimmer box 200 is at the correct angle with respect to the pool wall 22.

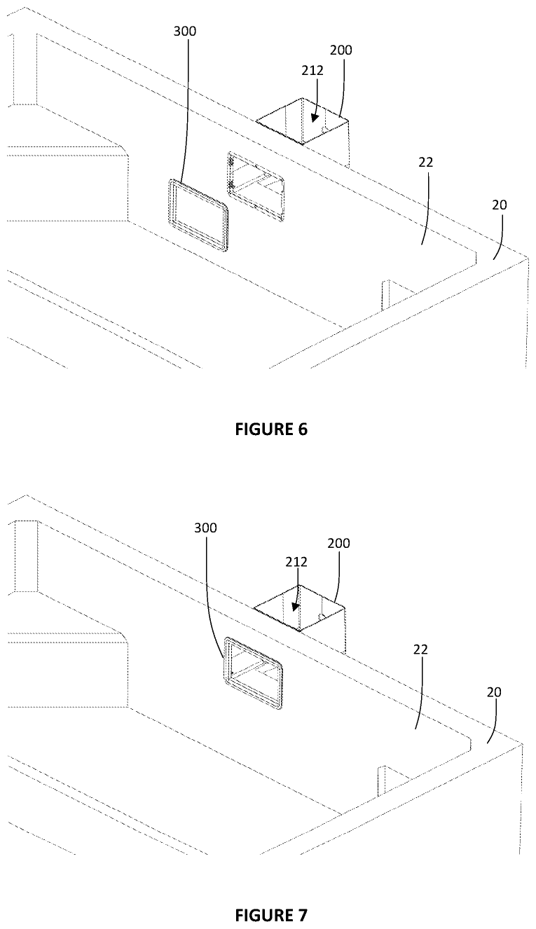

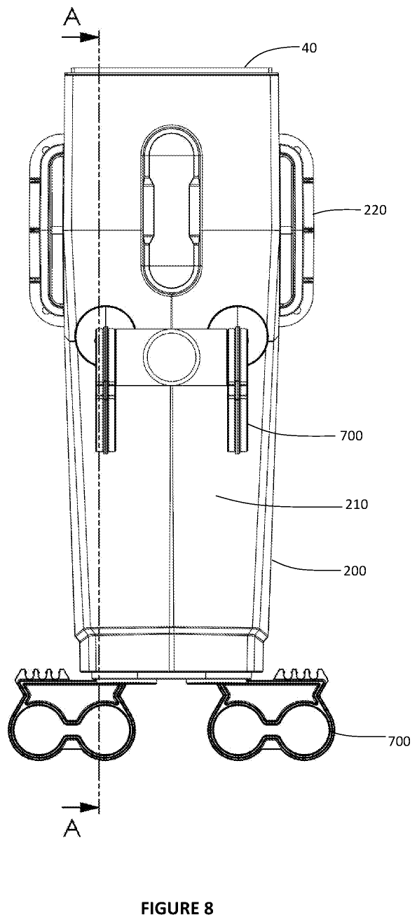

FIG. 6 illustrates the skimmer box 200 mounted in the pool wall 22, via mounting component 100, from the other side. As can be seen, the mouth of the conduit 216 located in opening 112 of the mounting component 100 reveals the connectors 126, 216. A fascia 300 is provided to cover and seal this region of the aperture 24, as shown in FIG. 7.

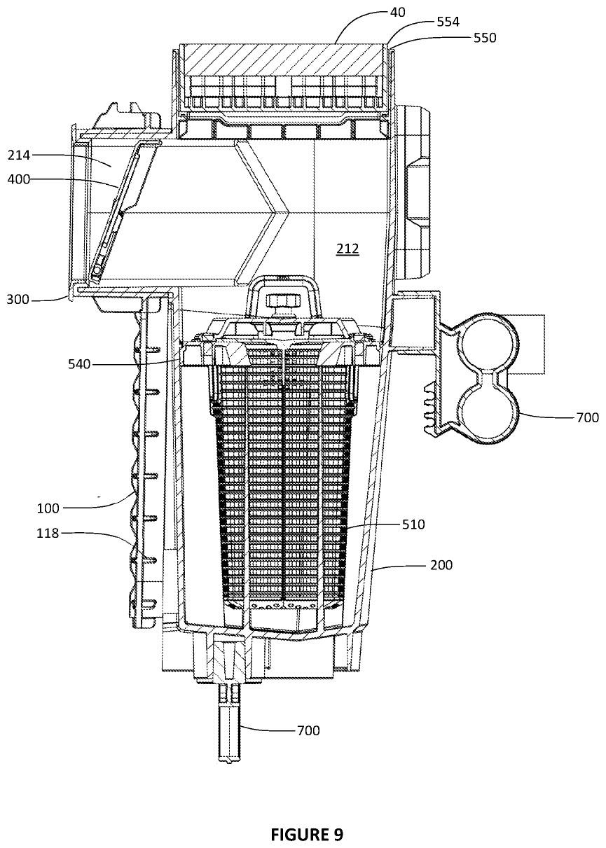

FIG. 8 illustrates a rear side of the skimmer box assembly 10 with FIG. 9 illustrating a cross-sectional view across line A-A of FIG. 8. As can be seen, various other components are attached to the skimmer box 200 including the mounting component 100, the fascia 300, and pipe supports 700.

The door 400 can be seen located inside the conduit 216. The door 400 assists with one way fluid flow by preventing backflow from the skimmer box 200. The basket assembly 500 can also be seen inside the cavity 212 of the skimmer box 200. The conduit 216 forms a water inlet. At a bottom end of the body 210 of the skimmer box 200 is an outlet in fluid communication with a suction line of a pool filtration system. In use, water is drawn from the pool into the conduit 216, into the cavity 212 of the body 210, through the basket assembly 500, and out of the outlet with debris over a certain size being captured by the basket assembly.

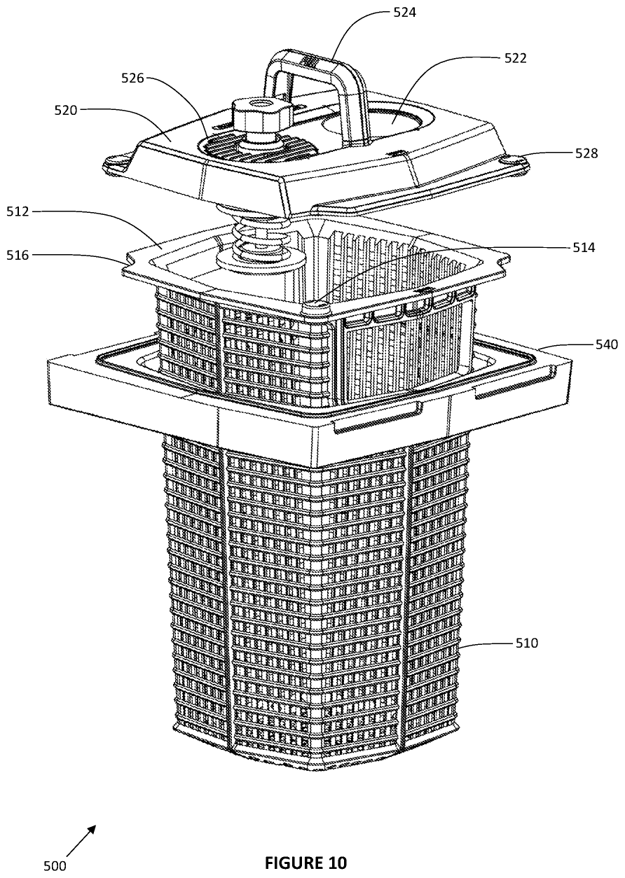

FIG. 10 illustrates the basket assembly 500 which primarily comprises a basket 510 with a grid structure configured to sieve water passing therethrough and capture larger items of debris. The basket 510 also a collar 512 with magnets 514 on opposite sides of the basket 510 and, spaced from the magnets 514, notches 516 on opposite sides of the basket 510. The magnets 514 and notches 516 are spaced along the collar 512. With respect to the illustrated basket 510 they are located on different pairs of opposite corners, but it should be appreciated that the basket 510 could be round or circular with no corners in which case they are preferably spaced apart around the collar 512.

The basket assembly 500 also comprises a skimmer box plate 520. The skimmer box plate 520 has a hole 522 which may be used with a vacuum apparatus, such as a suction driven pool cleaner (not shown). The skimmer box plate 520 also has a handle 524, for easy handling and removal, and an adjustable valve 526. Notably, like the basket 510, the skimmer box plate 520 has magnets 528 on opposite sides of the skimmer box plate 520 as well.

The basket assembly 500 further comprises a dress ring 540 that the basket 510 can sit in. In use, the dress ring 540 is mounted in the cavity 212 of the body 210 of the skimmer box 200. The basket 510 fits within the dress ring 540 with its collar 512 abutting an upper surface thereof. The dress ring 540 has magnetically attractive components (not shown) such as steel or ferrous pins which may be mounted within the dress ring 540 from the underside. It should be appreciated they could be located inside the dress ring 540 itself, mounted from the top, or mounted externally as well. It should be appreciated that the magnetically attractive components could be magnets themselves. In such a case, it should be appreciated that the other magnets of the basket assembly could be magnetically attractive metals rather than magnets.

In use, the magnetically attractive components can be used to magnetically capture and retain the basket 510 via its magnets 514 and magnetically capture and retain the skimmer box plate 520 via its magnets which can reach the dress ring 540 unobstructed due to the notches 516 in the collar 512 of the basket 510. It may be possible for the magnetic attraction to pass through the collar 512 without need for the notches 516. This may be particularly advantageous for a circular basket assembly 500 where continuous relative positions are possible. Either way, it would require stronger magnets to provide the same level of attraction and is therefore not preferred. Advantageously, the magnetic attraction overcomes buoyancy and retains the various components of the basket assembly 500 together. As both the basket 510 and skimmer box plate 520 are symmetrical they can be placed into the dress ring in any of the four orientations allowed by the square shape.

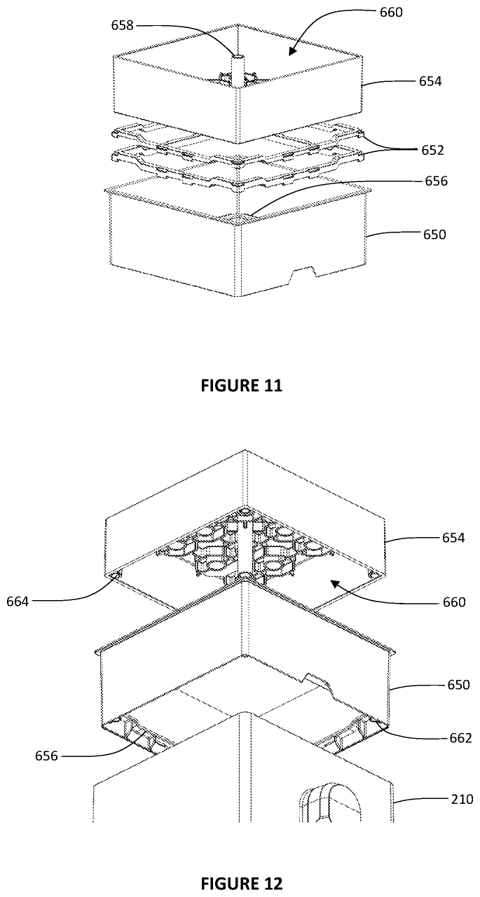

FIG. 11 illustrates a height adjustment system for a lid of the skimmer box 200. The height adjustment system comprises a sleeve 650, spacer rings 652, and a lid 654. The sleeve 650 fits into a top of the skimmer box body 210 and has an inwardly extending shelf 656 upon which the spacer rings 652 can reside. The lid 654 can then slide into the sleeve 650 and sit on top of the spacer rings 652. The height of the lid 654 relative to the skimmer box 200 can be varied by increasing or reducing the number of spacer rings 652 (including by having no spacer rings 652). Differing sized spacer rings 652 may be utilized such as, for example, 5 mm and 7.5 mm rings to allow any height to be achieved above 5 mm in 2.5 mm increments.

The lid 654 has a solid side and an open side formed by hollow 660. The lid 654 can be flipped depending on whether it is to be used as a standalone lid, with the hollow 660 facing down, or whether it is for use with pool surround materials such as a tiles with the hollow 660 facing upwards. When tiled, for example, the tiles should be cut to fit within perimeter of the lid 654.

The lid 654 has a tool receptor 658 configured to allow connection to a tool (not shown) for lid removal. The tool receptor 658 is centrally located and can be accessed from both sides of the lid 654 such that it can be used regardless of the orientation of the lid 654. In use, tool receptor 658 should be made accessible even if the lid 654 is tiled to enable removal of the lid with the tool.

FIG. 12 illustrates a magnetic locking mechanism comprising magnets 662 located in the sleeve 650 and magnets 664 located in the lid 654. The magnets provide sufficient magnetic force to retain the lid 654 to the body 210 of the skimmer box 200. Preferably the combined magnetic strength is sufficient to provide a pull force equivalent to at least 10 kg. In the case of a tiled lid 654, magnets are not required as the tiles provide sufficient weight. The lid 654 may therefore have pockets to accommodate magnets, but magnets may optionally be installed in the pockets depending on whether the lid 654 is going to be tiled or not. It should be appreciated that some of the magnets 662, 664 may be replaced with non-magnetic magnetically attractive components such as components made of ferrous materials.

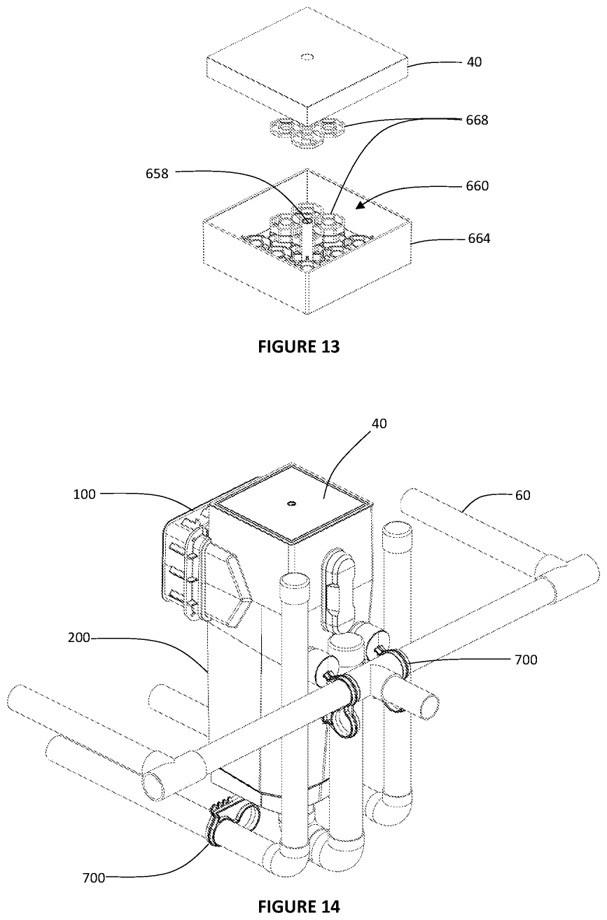

FIG. 13 illustrates the lid 654 with its hollow 660 facing upwards to receive a tile 40. As tile thicknesses vary, one or more packers 668 can be utilized by the tiler as needed to fit the tile 40 flush with the upper edge of the lid 654 and tool receptor 658.

FIG. 14 illustrates the skimmer box assembly 10 with pipework 60 being held by pipe supports 700. The pipe supports 700 are removably affixed to the body 210 of the skimmer box 200 and have an annulus through which a pipe 60 can pass. The pipe supports 700 are configurable as needed depending upon pipework 60 requirements. As can be seen, the pipe supports 700 can provide both vertical and horizontal support to pipework 60. Each pipe support 70 has two annuli, generally forming a FIG. 8 shape, to allow for parallel pipes 60 to be supported if needed.

Advantageously the skimmer box 200, particularly when used as part of the skimmer box assembly 10, can be inserted and affixed into a pool wall 22 after pool construction. No further finishing or backfilling is required. The skimmer box 200 is simply slid into the aperture 24 of the pool wall 20 and mounted connected thereto, preferably via mounting component 100. The connection and mounting of the skimmer box 200 fully supports the skimmer box 200, even when laden with water, meaning no backfilling or additional skimmer box support during construction of the pool is required.

Additionally, the skimmer box 200 and skimmer box assembly 10 may have many features of convenience such as magnetic retention of the basket assembly 500, reversible and height adjustable lid 654, magnetic locking of the lid 654, tile packers 668, and/or pipe supports 700.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A skimmer box for a pool, the skimmer box comprising:
a body having a cavity therein;
a conduit extending from the body, the conduit being configured to be received in an aperture of the pool and fluidly connect an inside of the pool with the cavity; and
one or more connectors configured to operatively connect with a corresponding connector in the pool to mount the skimmer box thereto.

2. The skimmer box of claim 1, wherein the one or more connectors are located on the conduit.

3. The skimmer box of claim 2, wherein the one or more connectors are located on an inner surface of the conduit.

4. The skimmer box of claim 2, wherein the one or more connectors may comprise one or more projections.

5. The skimmer box of claim 4, wherein the one or more projections are resiliently deformable.

6. A skimmer box assembly for a pool, the skimmer box assembly comprising:
a skimmer box having a conduit with one or more skimmer box connectors; and
a mounting component having a frame portion with one or more pool side connectors, the mounting component being configured to be affixed to or into a pool wall;
wherein the skimmer box connectors operatively connect with the pool side connectors to mount the skimmer box into a wall of the pool.

7. The skimmer box assembly of claim 6, wherein the skimmer box comprises
a body having a cavity therein;
a conduit extending from the body, the conduit being configured to be received in an aperture of the pool and fluidly connect an inside of the pool with the cavity; and
one or more connectors configured to operatively connect with a corresponding connector in the pool to mount the skimmer box thereto.

8. The skimmer box assembly of claim 6, wherein the frame of the mounting component has an opening therethrough.

9. The skimmer box assembly of claim 6, wherein the mounting component has a skirt portion configured to be received by an aperture of the pool.

10. The skimmer box assembly of claim 6, wherein the mounting component comprises one or more securement members.

11. The skimmer box assembly of claim 10, wherein the securement members comprise ribs.

12. The skimmer box assembly of claim 6, wherein an inner surface of the frame may be configured to line the aperture of the pool.

13. The skimmer box assembly of claim 6, wherein the mounting component comprises a channel configured to receive an end of the conduit of the skimmer box.

14. The skimmer box assembly of claim 13, wherein the channel is U-shaped.

15. The skimmer box assembly of claim 13, wherein the pool side connectors are located in the channel.

16-36. (canceled)

37. A method of affixing a skimmer box to a pool, comprising the steps of:
inserting a conduit of the skimmer box into an aperture located in the pool; and
connecting one or more skimmer box connectors of the skimmer box with a corresponding connector in the pool to mount the skimmer box thereto.

38. The method of claim 37, further comprising the step of affixing a mounting component to the pool.

39. The method of claim 38, wherein the step of affixing the mounting component to the pool comprises embedding the mounting component into the wall of the pool.

40. The method of claims 39 wherein the pool is a cast concrete pool and the mounting component is moulded into the pool during casting.

41. A method of constructing a pool, comprising:
preparing a pool mould including locating a skimmer box mounting component in the mould;
pouring a cementitious material into the mould, and allowing it to set, to form a concrete pool shell;
removing the pool shell from the mould with the skimmer box mounting component embedded therein.
